(19) United States
(12) Patent Application Publication
(10) Pub. No.: US 2014/0188578 A1
(43) Pub. Date: Jul. 3, 2014

(54) Keychain Poll Type Device

(71) Applicant: Peter Prestegaard, Nanuet, NY (US)

(72) Inventor: Peter Prestegaard, Nanuet, NY (US)

(73) Assignee: Peter Prestegaard, Nanuet, NY (US)

(21) Appl. No.: 13/730,587

(22) Filed: Dec. 28, 2012

(51) Int. Cl. G06Q 99/00

(52) U.S. Cl. CPC G06Q 99/00
USPC 705/12

(57) ABSTRACT

The i2C mini tool is personal, pocketable, non-class oriented, and will be part of a simplified, secure system designed to provide unbiased input by all vote eligible citizens on selected topics, assisting government to make better decisions. Input will occur responding to centrally posed statements and questions. The qualification process to use the device will be tied to local Voter Registration acceptance. It will also be a tool to offset “special interests,” while increasing citizen “buy in” on difficult decisions. Responses will not be subject to statistical error; results will be securely compiled and audited, then rapidly made known to elected officials, the populace, and the media. A secondary use for the tool will be as an identification device, to help justify carrying it continually; thirdly, the system and device over time will help to increase the number of persons who are vote registered and become active opinion sharing citizens.

Portions of the disclosure of this patent application contain material which is subject to copyright protection. The copyright owner has no objection to the facsimile reproduction by anyone of the patent document or the patent disclosure, as it appears in the Patent and Trademark Office patent file or records, but otherwise reserves all copyright rights.

The following text, descriptions, examples, conclusions and summaries, as well certain words used in context “toggle,” “toggling,” “toggler” and the unique design and certain features and benefits of the i2C system and personal tool, are © copyright 2012 by Peter Prestegaard, The Legacy Chronicle, New York. All rights reserved.

### 1. BACKGROUND

1.1.1. I believe in America. I believe the American ideal, while not perfect, is the best form of government, freedom and democracy yet discovered.
1.1.2. What is the heart of the American ideal? To me, one man or woman, one vote. That is, each citizen can and should make a difference, even if small, by sharing his/her thoughts on direction for the future. This is done today by voting for a representative, who then makes, with due consideration, the actual decisions about action on behalf of all in consideration of majority rule. Whatever the outcome, this vote may be summed up by two words: “I Count.”
1.1.3. This is a wonderfully justifying, simple and unifying thought, if so often not the case in other forms of society. In this country, however, we thankfully believe the election process, as a whole, is credible.
1.1.4. Now, it is time for something more. For as we develop and learn and in our headlong rush to the future, it seems that too seldom does each individual actually count. And even then, too often the 1:1 vote/count majority rule idea, is overridden by special interests. In part, this results in the current nadir of popularity of Congress and Washington generally, and gridlock in moving forward.
1.1.5. Today, what each citizen says and feels, in a considered way, at any particular time, on important matters, not just once a year on Election Day, it seems should also have importance and value.
1.1.6. Just as our freedoms over the past century have evolved to finally include input for blacks and women, so today why shouldn't citizen's input evolve to have more meaning, more often, more timely, reflecting better education and better technology? Would not this help motivate direction the right way, and also improve “buy-in” for actions and cohesiveness by the population at large? Maybe, maybe not, in truth. But isn't movement in this direction a fundamental need and coming?
1.1.7. Overseas, such as in Germany, there are special votes to provide input on issues. But their system can be cumbersome, and often not timely. Here, so far anyway, except on certain dull matters, do we even vote on important issues? No. We still rely almost solely on our representatives to “do the right thing.”
1.1.8. Our 16th President in his brief, pointed late 1863 address, most poignantly and memorably summarized the innate need for common man, as that most horrible of wars, the Civil War, finally began to wind down. Lincoln said “ . . . these dead shall not have died in vain—this nation, under God, shall have a new birth of freedom—and government of the people, by the people, for the people, shall not perish from the earth.” Could there be a better sum up? Where are the power brokers and special interests given priority here?
1.1.9. Many things have materially changed from our country's founding. Mostly, fortunately so. Our forefathers never would have considered that we should not continue to evolve and make even more meaningful their core ideals as conditions allowed, for the good of the country as a whole. So . . . later came the vote to women and blacks. We don't now need a new system, we just need to evolve what we have, and better use today's capabilities and tools, again moving closer to the ideal.

### 2. BRIEF SUMMARY OF THE i2C INVENTION

2.1.1. Providing a tool as part of a coherent system to help advance the democratic process and attune it more fully to the conditions and capabilities of today, is what this patent application is about. It is for a simple, and what is ultimately meant to be a close to universal tool of, and for, all vote-qualified citizens. As conceived, properly and fully implemented, it could be a tool unlike any other, making truly meaningful, more often, more broadly, those deeply personal and democratic words: “I Count.”
2.1.2. Because a citizen voter already counts once, due to their ability to vote for a representative, albeit usually only once a year or less, the newly evolved, here presented, idea is called the I Too Count system, or “i2C” for short.
2.1.3. It is both a physical tool and a system. The heart of i2C, and the focal point of this application, is a keychain-size device with related dedicated processes that do one thing: directly provide credible input to those who govern. An unfiltered, prompt, sharing of thoughts on clearly defined issues. Elected persons still implement; i2C will simply provide more secure, virtually error free compiled knowledge of what the populace wishes. Thereby it should be a new tool to act as a real offset to special interests.
2.1.4. The compiled information will also go to the monitoring fourth estate, the press, so all may know what aggregate citizens' positions truly are.
2.1.5. To be clear, even fully implemented, i2C does not in any way void our system of representational democracy, or the current voting process; rather its purpose is more fundamental: to help re-prioritize, re-direct and guide. Simply put, to act as a new aid to better decisions. Thereby also making being a US citizen more meaningful.
2.1.6. Should the elected representative, for whatever reason, ignore or diverge materially from the clearly expressed, now clearly known desire of the majority he represents, since usually result information would be available by precinct (but not by voter), he can, of course do so. Where he feels strongly, or has good reason, he not only should but must do so. But any diverted or special interest action will, after the i2C system is in place, of which the keychain device is the heart, be much more obvious, and any diversion must have much better logic.
2.1.7. Keeping the compiled results credible by keeping the channel unique is the main reason for this patent, which is intended to be assigned to a credible not-for-profit to administer. This will be useful to keep results pure and allow elimination of a distracting profit motive. Its implementation will not be easy, since commercial, political and local systems will need to work together to set up the support system.
2.1.8. The closest analogy to the physical description of the input device that is the subject of this application is an old time pocket watch formerly kept on a chain, like one with a cover that a person used to snap open to look at the time. In this case, the latter day version is envisioned to be on a keychain.
2.1.9. In fact, once awakened with a click, the face could show time and also a cameo photo of the voter as identification. It is envisioned there will be three sections: a top section that normally will show the time but during input will show the question number being responded to; the second section normally will show a likeness of the person the device is licensed to but during input will show the options for response controlled by a thumbwheel; and the bottom section which will be a fingerprint reader only active on start up.
2.1.10. Possible input likely would be listed on the bit-mapped screen and selected by a code designation such as a), b), etc., with the appropriate selection scrolled to, and a tone to indicate acceptance when the scroll wheel is depressed. Or alternatively, the screen might be mapped with a continuum bar to indicate strength of conviction.
2.1.11. There would also be a check and feed back routine before the upload occurs to ensure that it reflects properly the input of the voter.
2.1.12. Because power is a challenge with touch screens, initially it may be a non touch screen with responses accessed by thumbwheel until a longer-lived battery or inexpensive magnetic recharge system or similar such solution, such as is now emerging, becomes more widespread.
2.1.13. Besides the system and concept, the first iteration for the keychain device encompasses a rugged size consisting of a screen, a fingerprint read aperture, logic, memory, encryption method, communication chips, antenna, notification method, chirp source, power source and two side buttons plus a depressible thumbwheel, that work together to first identify the user and then to provide input for transmission and compilation via a secure network.
2.1.14. It is not for voting, though it is true a version could be seen to evolve eventually to replace some physical site based voting. The result is even further from the plethora of polls today, and may not replace those either. It is in between, a new idea from existing methods, a clear, direct, more in depth and personal input based on a device, with inputs potentially summed for the entire voting populace, ideally most anywhere they happen to be, with the result to be conveyed to involved representatives as well as the press at large.
2.1.15. The device will have an important sub-use and that is at any time to act as a citizen identification method. The first use will occur as a result of the known secure issuance and photo rendering of the licensee on the screen. The more in depth level could entail the active identification of the user via fingerprint. And conceivably a third level, if the device is within range of a connection, would be attestation by the Voting Registration that the person is on the active rolls.

### 3. DEFINITIONS

### Toggle, Toggling, Toggler

3.1.1. We call requests for input from the citizen voter a “toggle,” and the action of using the device to give that input, “toggling.” The authorized voter who does the toggling is the “toggler.”

### 4. PRIOR ART

4.1.1. A review of existing art both at USPTO headquarters and via the Google Patent search system, found nothing that we consider close to the comprehensive yet simple device and dedicated distributed system presented here with potential for incremental use, combining small size of input device, sealed security, possible scale up utilizing existing encrypted communications networks, disciplined single purpose media interaction, and identification processes, all with small size and weight, and end user ease and simplicity of use.
4.1.2. There have been, however, many, many attempts to devise automated polling or improved voting systems. Those we have found having some semblance to our fundamental ideas follow.
4.1.3. The closest approach to the secure keychain input device for polling or voting purposes, which is at the heart of this patent submission, appears to be U.S. Pat. No. 4,377,870 of Mar. 22, 1983 for an Electronic Audience Polling System. The device is antiquated for today's use however, is large, and does not include the method of input, capacity for multi tiers of response, does not appear to be readily scalable, makes little pretense of being secure, private or to identify and then protect the user, among other fault factors.
4.1.4. A European patent EP1353299A2 priority dated Apr. 12, 2002 called A Method for Electronic Polling and Wireless Polling uses a noticeably larger and potentially scalable device where the input can be read on a screen and output provided. The device as described is not meant to be continuously carried, does not have close to the same security as i2C and does not have the flexibility of instant identification or separate notification capabilities that should be in any serious system to be adopted in the US.
4.1.5. A third instance does not appear to be patented since it is a system without a particular device or program. The text and idea however were copyrighted by Cranor and Cytron, for an IEEE presentation in 1997. It is called Sensus: A Security Conscious Electronic Polling System to operate using the Internet. The challenges and theories described here are scalable and the closest to our goals for system needs. They describe well the requirements and basis for registered voters to vote securely and privately, and accurately state the needed functions of the registrar, validator and tallier. However, their input device is to be any computer and the use appears to rely on the voter negotiating a series of steps that are off-putting at the least; the validator and tallier steps may be cumbersome too so they do not address the solutions found in this application to patent the mini i2C input device.
4.1.6. Search also revealed a fourth copyrighted but not patented concept called icount.com which appears to be a light duty web site used for political polling purposes, mainly in Utah, again on the internet that is representative of several similar such programs. There is no set device, the system is informal and security and identification appear insufficient for a serious polling or distributed voting system. It does not appear readily and securely scalable either.

### 5. DETAILED DESCRIPTION OF i2C

### Unobviousness/Competition

5.1.1. What is new and unobvious about the i2C mini device and related system? First look at alternatives aimed at providing a similar result. A popular non-patentable, but copyright-able alternative today is the personal poll, such as the NY Times, Quinnipiac, Gallop, etc. Such polls are subject to the following problems:
   timeliness of result;
   often one needs to subscribe and pay to promptly learn the copyrighted outcome;
   independence and accuracy of compilation; today, results could be subject to manipulation, or human intervention in multiple ways, and rely heavily on the credibility of the compiler;
   intended or unintended bias in questions individually and humanly asked, including specific words and even tone of voice;
   the selection process of who is polled;
   the location and geographic areas where questions are asked;
   the effect of a person being publicly polled and the lack of secrecy in the taking;
   the minimal amount of time that is allowed for a thoughtful response potentially resulting in a “knee-jerk” type of response;
   polls deal with simple, mostly one dimensional, problems;
   per the NY Times recently, the fact that such polls are often known to be “gamed” to move toward a desired outcome by the sponsors;
   poll notoriety, herd mentality and spotlight psychology can have a “send a message” impact on the person being polled, so they may not truly give their private end thoughts, but rather try to manipulate, or try to be responsive to, the opinion of others in some way, perhaps on account of being asked as a representative of many;
   and finally, a standard poll today uses the input of a few hundred persons to represent millions, clearly an opportunity for error, which is well defined in statistical theory. This results in so-called statistical polling or sampling error, a “confidence interval” and the plus or minus amounts that are listed along with poll results due to sampling theory, since the whole population is not queried; often such differences are material; in some cases, error parameters could obviate or totally change the end result; at the least, the acknowledgement of such error potential leads to confusion and uncertainty.
5.1.2. The NY Times study analyzing the inaccuracy of the various polls, including its own, after the 2012 Presidential election, found that most polls were notably off the mark and often leaned heavily toward Republicans, possibly intentionally. The heretofore esteemed Gallup Poll at this time was dead last of the major polls in terms of accuracy according to the Times study, of comparable results.
5.1.3. i2C simply has none of these problems or potential problems or at the very least, will be structured to minimize or eliminate their dissonance.
5.1.4. For a different way to get poll-like information, there are apps such as Google vote on an iPad, iPhone or similar device, which operate similarly to the icount idea listed above. But this channel is potentially, if not actually, commercial or biased, often includes data capture, and thereby is fraught with many potential conflicts of interest and questions about credibility and privacy. Using such would further dilute the importance, prestige and assuredness of the results, and open them to charges of bias, diffusion and/or potential manipulation. Such a source of input, while having some value, is unlikely to over time be heavily leaned on as a credible legislative suasion tool but more as an artifact of interest.
5.1.5. Without a dedicated device, apps simply can not have the secondary benefits of i2C either and, at least as conceived so far, could never even start to be thought of as a replacement for normal voting.
5.1.6. The i2C mini device is to be dedicated, simple to use, single purpose. The support system will be even-handed, comprehensive and carry no baggage. It is also envisioned to be self-funding. It will have a clear reason. The pocket tool subject of this application is at heart both simple and mechanical. It could also be quickly accessed, provide privacy, and not be partisan or location dependent.
5.1.7. Toggled results will utilize dedicated software and encrypted security to split the input, identifying who has toggled, from what precinct, but not what they toggled for privacy, no matter where the toggling takes place, due to embedded codes, is an added advantage over a fixed physical poll location. So a traveling person could still timely participate without cumbersome, sensitive, controversial and expensive absentee-type ballots, even from outside the country. Then results will be compiled anonymously, pyramiding them as need be into a local outcome and a national summary.
5.1.8. Overall, the i2C mini keychain device should be similar in size compared to many of today's Bluetooth-based, multi-function car “keys.” Initial concept is envisioned to have a glass screen, made of modern materials to save weight, and an optic reader with software that can scan a person's thumb or fingerprints for positive identification. An adjacent screen can depict numbers, or in other ways denote toggle selections identifying events in need of action, as well as confirm the input selected. Unless the person is properly identified by the device, he or she may not participate in the toggling.
5.1.9. First iteration is likely to be approximately the thickness of today's iPhone, but less than ¼ the size of its other dimensions. It will feature low weight and bulk, so it can fit reasonably and comfortably on a keychain, and readily be kept in a pocket or purse.
5.1.10. The device should have a long life rechargeable battery with circuitry to husband power so that it can last for an extended period while staying dormant between uses. It may in the future be recharged passively, without an actual connection or with a USB port. In the initial iteration, it may or may not be backlit, or side lit, with the choice made considering cost and the availability of other patents, but also importantly to maximize the time possible between recharge.
5.1.11. To help ensure security of transmission, it is possible initially that the device may have to be put in near proximity of a hard wired device. Such input “mating” might best be found at libraries or in private internet systems. Alternatively, wife or cell phone sub layer transmissions may be used, provided encryption security goals are reached.
5.1.12. The initial iteration of the device also will have a vibration capability to notify the owner when the battery is low or perhaps also when there is an outstanding toggle needing his or her input.
5.1.13. It will also have a sound source to provide feedback as the toggling takes place.
5.1.14. Each registered voter is envisioned to be licensed for the use of his or her own i2C device. In quantity (with some 160 million currently registered voters) it is believed the device can be produced for $30-40, or less, each. It is to be provided by license to legally registered voters who pass a simple operational test, for about a $60 fee. Eligibility is to be determined solely by the official local Voter Registration/Board of Elections (“VR”).
5.1.15. This concept anticipates the VR function will keep a portion of the license proceeds, perhaps around $20 for each unit issued, for its operations. There is no profit for any party involved. VR personnel are envisioned to do identification, security encoding, demonstration and product delivery. There could also be a smaller annual renewal or maintenance fee to help offset on-going costs of administration. At issuance of the i2C, VR will use a special “mother” device to embed instructions and encrypted information unique to each mini i2C unit.
5.1.16. Among other factors, given expected special interest opposition, since lobbyists often are diametrically opposed to wishes of the population at large, this idea will not be easy to implement. Yet another reason for doing the project properly, and for this patent.
5.1.17. Current elaborate patented voting systems are not considered competition for the i2C mini device and system because they require lengthy set up for each election, are site based, highly expensive to administer, cumbersome, only subject to infrequent use, not issue oriented, not personal, and to date make limited use of today's technology.

### 6. PRACTICAL USE OF THE DEVICE

6.1.1. Will each issue to be toggled be fully described on the i2C device itself in some way? No. There is not close to enough screen real estate, which would defeat the concept of a small truly personal device to be kept on one's person. And anyway, we don't wish to bypass the press but rather to have a program where they remain central to the result.
6.1.2. At some future point, a version could receive internally questions (the toggle) for print out wirelessly, to a printer. A future version could even possibly transpose this information and potential responses into spoken words conveyed on a headset. But those are “down the road.”
6.1.3. In the first iteration, the idea is that public media, especially newspapers, will publish the toggle, that is the information on which input is being sought, in sequence, with potential lettered or numbered responses listed, and provide information on the timing. A secure internet web site would show exactly the same wording. Such input of course would be open to commentary, but such would be separate and labeled so.

### 7. A TOGGLE EXAMPLE

7.1.1. The best way to illustrate i2C uniqueness is an example. An issue that appears ripe for toggling would be to get voter input on our national debt. First, there would be a factual statement and then related questions or sub ideas for response, both published exactly in the press and internet. Toggled results should provide legislators clear guidance and direction. There will also be commentary and further explanations, no doubt, to help with guidance, at the option of the press. Each citizen (toggler), would input his or her conclusions on the toggle issue on their i2C personal device for uploading.
7.1.2. Example Statement: Today, the Federal Government has incurred over $51, 786 of debt for each man, woman and child US citizen. The Census Bureau says there are 310 million citizens of whom 210 million are of voting age and there are about 160 million registered voters. Annual deficits in government spending are causing a rapid rise in debt owed. Such debt increases simply mean we are pushing off current expenses as obligations for future generations. In part, this resulted in the so-called fiscal cliff. No one disagrees that balanced expenditures and income are worthy goals; but all too often, increasing debt is simply too easy. We need a firm plan to get this under control.
7.1.3. One option to right the ship, so far little discussed, would be to have people who have benefited from living in this country, shoulder their fair share of debt, equally and individually. In financial circles, this is called an “ultimate securitization.” Essentially, we are a nation of individuals. We are as good as the sum of all of us. We also literally owe any success we may have had, surely at least in part, to being a citizen of this country.
7.1.4. Broadly adopted, a plan to have individuals directly shoulder their fair share of the national debt could also assist in restoring the US's financial rating. Fully implemented, each person would be encouraged, or perhaps required, to repay his or her individual debt share for a fresh start, either immediately, at some future point, or at death. Once done, such persons should be honored as citizens who have done their duty. As an added incentive, living individuals who repay their fair share of US debt should benefit immediately from a reduction in their annual income taxes, since they will have reduced overall US debt, and therefore similarly reduced related US interest payments.

### 8. EXAMPLE FOR INPUT USING TOGGLING WITH AN i2C PERSONAL DEVICE

i. Do you agree in general with this idea to reduce US debt? a) yes, it should be required by each citizen able to do so at some point in one's life or at death; b) yes, but it should be voluntary; c) no; d) don't understand.
ii. Should a public listing of patriot “honor roll” participants be compiled showing those citizens who pay, or pledge to pay, as do some European countries such as Norway, with their taxes? a) yes, both continually as to the amount of tax paid or pledged or debt repaid; b) no to both; c) yes, only for debt repayment; d) yes, only for the amount of taxes paid each year; e) don't understand.
iii. If an individual's share of public debt is still unpaid at his/her death, rather than burden future generations, should such amount be a required first obligation to pay, after a minimal portion is provided to family for death expenses, and before the remainder of the estate is distributed? a) yes; b) no; c) yes with reservations; d) yes and the person who died should also be able to designate others for whom individual debt shares could be repaid as well; e) don't understand.
iv. If the answer in #iii above is some form of “yes,” that is, a), c) or d), how much should the initial exemption be? a) $0 except for $25,000 to cover funeral and death expenses; b) $100,000; c) $250,000; d) more; e) doesn't apply or don't understand.
v. Should such individual obligation also be assigned to non-citizens in residence in the US after they spend cumulative time living here, such as a) two years; b) five years; c) some other period; d) disagree with this idea; e) don't understand.
vi. In the future, if the annual US budget is in deficit, should any such deficit amount immediately be made a new individual obligation? a) yes, using an increased tax at the same progressive rates then in effect for a given income level; b) yes, but any overage should be equally shared, effectively as a new flat tax; c) yes, any overage however could optionally be added to the total amount to repay at some future time in one's life or at death; d) no; e) no, and an actual vote or toggle of all voters should be required to approve any new deficit; f) don't understand.
vii. Perhaps a reasonable theory would be that overall Federal debt should be allowed to grow over time slightly, basically at a pace consistent with increases in GNP. This would be similar to a widely accepted theory that it is ok for a company to keep a relative amount of debt as it grows. Do you agree? a) yes; b) no; c) don't understand.
viii. Should US based corporations, and foreign-based corporations operating in the US, be required to pay (not accrue) taxes in cash each year based on prior year domestic and international earnings, net of local taxes? a) yes; b) no; c) do not understand.
ix. When a person has patriotically repaid his or her fair share of national debt, should he or she get credit against current and future income tax payments because the government is saving interest by having less debt? That is, at today's government paid interest rates, this could be about a $500 tax credit each year for each citizen who repays the defined “fair share”, or $1000 for a couple. a) yes, with a deduction amount in future years to vary depending on the average interest rate then being paid by government; b) yes and if they repay the debt for others as well, they should also get a permanent deduction for this; c) no, the government should itself be able to keep the reduced taxes to apply to other expenses; d) don't understand.

This is just one example of how an i2C system/device could be used to inform, to find a sense of where the population at large stands on key matters and to encourage them to get on board as well; majority rule is well understood. Initially, it is envisioned a range of from one to not more than ten questions could be part of each toggle session.

### 9. SURROUNDING FACTORS USING THE i2C DEVICE

9.1.1. Once the issues are defined clearly, provided in advance via media and the internet, and no doubt commented upon by experts, then select voter precincts up to or including all vote eligible citizens would receive notice that i2C devices will be available for toggling, when, and for how long. Text and statements such as the above example then will be provided to the media as the toggle. At the designated time, access for upload will be opened and responses must be received within a designated time frame.
9.1.2. Initially, the response time allowed might be similar to the way a physical poll works, i.e. 12-15 hours to allow each citizen time to make a considered response. But a better idea would be to allow 24-48 hours to account for today's highly varied work routines and for the most thoughtful responses. A time left countdown could be included on the mini device. Results should not be published on an interim basis, which could sway later togglers, but conclusively provided not long after the toggle period closes.
9.1.3. The individual will sign in on the i2C keychain device, identify him or herself and then be allowed to progressively do the toggling, selecting his or her answers in sequence as the questions are set forth in the press. Before concluding, the toggler will be asked to do a review to help ensure that what was intended is in fact what was recorded before it is uploaded.
9.1.4. Then the i2C software and hardware will forward the input via encrypted text message, wife or perhaps an encoded free cell data channel, or similar, nearly wherever the person is, with the packet being routed to a secure central computer. There, the input will be split, after first confirming the single vote eligibility of each toggler, and thereby also letting the precinct, or any political party, know, if desired, who has toggled, but not what they toggled, to maintain privacy.
9.1.5. The process will be timely monitored by an independent auditing firm or group through mechanisms they will set up.
9.1.6. Toggling results are then made known publicly summed by precinct after the toggle period ends, and provided equally to all press.
9.1.7. There should not be too many toggle issues each year, as the process should be reserved to keep it “special” and for important issues.

### 10. MANUFACTURE OF i2C DEVICE AND ISSUE PROCESS

10.1.1. After controlled manufacture, preferably in the USA, it is intended that the i2C mini device will be provided for licensed use by vote registered citizens and, where required, paid for on behalf of them by scholarship, if they cannot afford to do so themselves, so that all 200+ million vote eligible citizens may have and use one. Those who cannot pay themselves will still receive exactly the same unit, except potentially for color, which will encourage payment if at all possible.
10.1.2. The i2C device should be provided by trained precinct workers to the voter after careful identification, with the license fee a way to raise money and help pay for the increasingly expensive election and VR process as well as the device. Such payment also would assist in covering costs for needed on-going recordkeeping by VR. It is envisioned that VR will have a master device to encode each pocket i2C system before it is issued, and that they will also at that time input the photo of the voter.
10.1.3. VR will also deny input from the device with an automated routine if the voter no longer qualifies as locally eligible at the time of each toggle or if he has already toggled.
10.1.4. Since the device will be small enough to fit on a keychain and be simple, sturdy and elegant with a long life battery, it is envisioned to have three buttons, one to initiate action, a second depressible toggle wheel to select responses for transmission; and a third to upload the responses. Ultimately, once power concerns can be overcome, a touch screen could be desirable for direct input.
10.1.5. The i2C mini device should include aural feedback and utilize simple identification, transmission, lockout logic, and flash memory to internally register the identified person's toggle responses. The face of the i2C device is initially conceived to be monochrome, possibly of paper white (TM Amazon) form, with an overall shape similar to a large teardrop or a small pear, for ease of input and uniqueness. It will contain three sections: a portion for fingerprint identification, a section where the specific toggle number being addressed is listed, and the larger part, where the toggle responses are selected. It is in this space that the small photo likeness of the licensed voter would be placed while the unit is dormant. It is planned to easily fit in the hand and to be able to be kept in a pocket or purse on a keychain.
10.1.6. Voting precincts will identify the user as a citizen and eligible voter in person at the time the device is issued and will have a master device to wipe and securely reset the memory of each i2C keychain unit. They will encode proprietary information about the issuing locale where the citizen is authorized to vote, and otherwise make it ready and coded for use. They will also embed the small photo of the citizen to be used for identification purposes and electronically re-identify the person at the time of each toggle input.
10.1.7. Precincts may also take other steps so the concept of one man, one vote (or toggle) by each eligible citizen voter is held as pure as possible.
10.1.8. Identification is to include having the person pass his thumb or finger over an aperture part of the screen of the i2C; therefore, the finger imprints will be embedded when the device is first issued, then internally matched at the time later toggles are sought, or if the device is used for positive i.d. purposes.
10.1.9. At issuance of the device, precinct workers will test that it works and jointly do a trial run toggle example of use with the voter. In all, it is believed that set up, fee payment and instruction should require perhaps five to eight minutes of time per average voter.
10.1.10. Once issued, use of each i2C mini device will be re-authorized automatically and can be updated periodically by a) a special commission; or b) legislative bodies, which could include local, state or federal agencies. There could also be a lower, modest annual license fee similar to, but much lower than, that for a driving license.
10.1.11. It is not contemplated that any non-public organization may use the device for profit or otherwise.
10.1.12. Where citizen voting rights are revoked, such as for certain felons, cessation of toggle ability could be readily centrally controlled as well as by sequestering the device itself
10.1.13. A small, independent non profit, non political, central coordinating office should be established so that particular care can be paid to the simple, direct and unbiased wording of issues, checking carefully the facts contained therein, which will properly set the stage and be used as a basis for distributed voter toggling, as well as for coordination of overall system use. Such central coordination is viewed as necessary to help elicit the most thoughtful responses and as a check on credibility, working along side the active audit group.
10.1.14. Once toggling results on an issue have been uploaded by the toggler, and the results audited and accepted, it is conceived that the i2C memory be wiped. Alternatively, this could also happen at the start of the next toggle.
10.1.15. It may appear that such a system, carefully implemented and controlled, could take the place of site based voting. This is possible long term, but not a near objective and could require other modifications such as to allow in some way a matrix of responses covering many lines.
10.1.16. While initially this is to be a US device for USA vote eligible citizens, there is no reason a variation could not be licensed, adapted and adopted worldwide.

### 11. PHYSICAL DESCRIPTION, FIGURES AND SCREEN LOGIC

FIG. 1—Physical sketch and elevations of a mini keychain i2C device showing basic simplicity and functions. Key to the parts shown and enumerated on the initial iteration are (1) the screen; (2) the toggle wheel; (3) the initiation of action button; (4) the communication button; (5) the fingerprint scan aperture; (6) the keychain attachment point; (7) an opening to replace the battery; (8) a usb charging, download and potentially programming port.

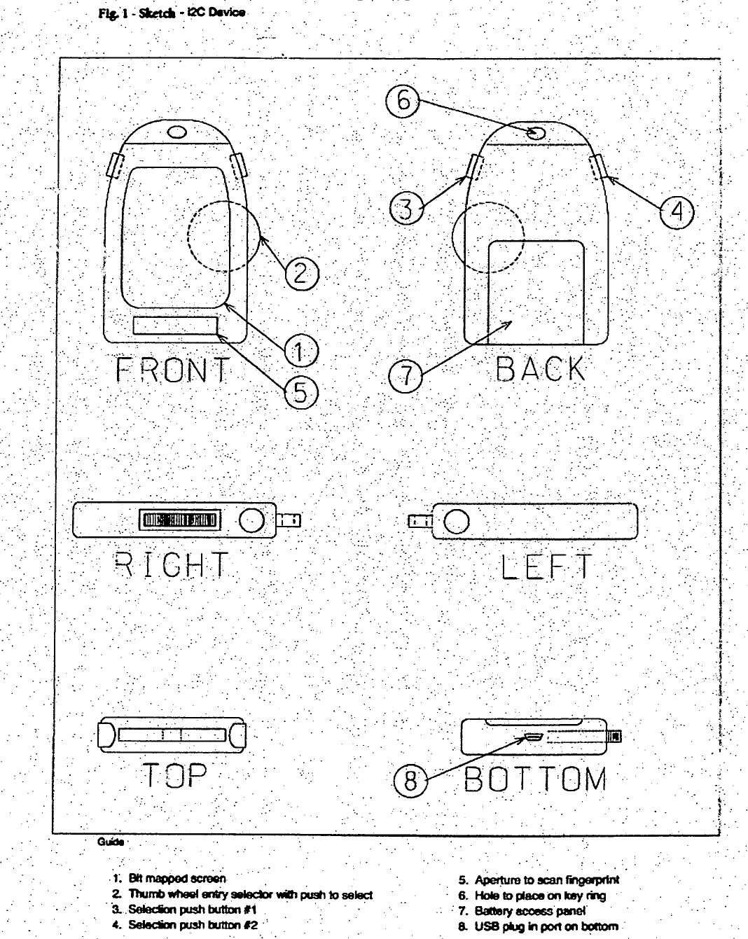

FIG. 2—Summary i2C Keychain Device and related system Flow Chart of Operation.

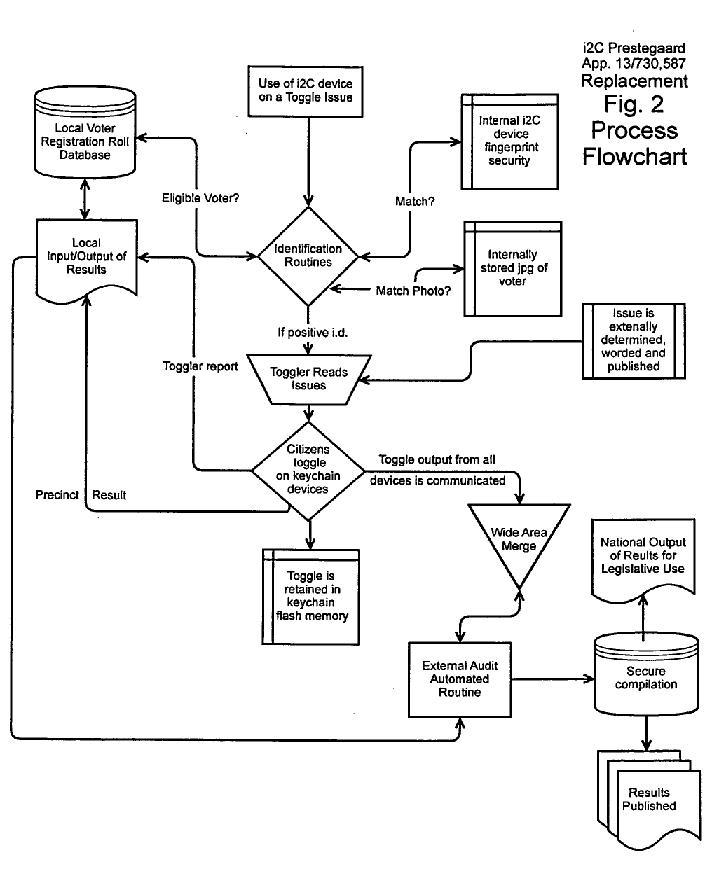

FIG. 3—A graphic depiction of implementation steps for the i2C system.

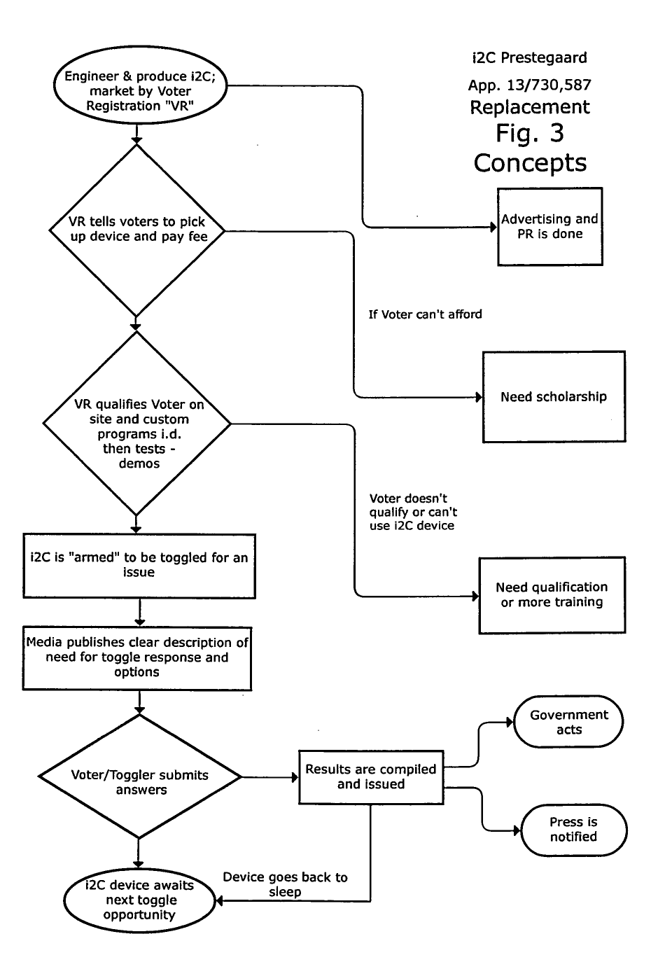

FIG. 4—3D depiction of a potential i2C mini device.

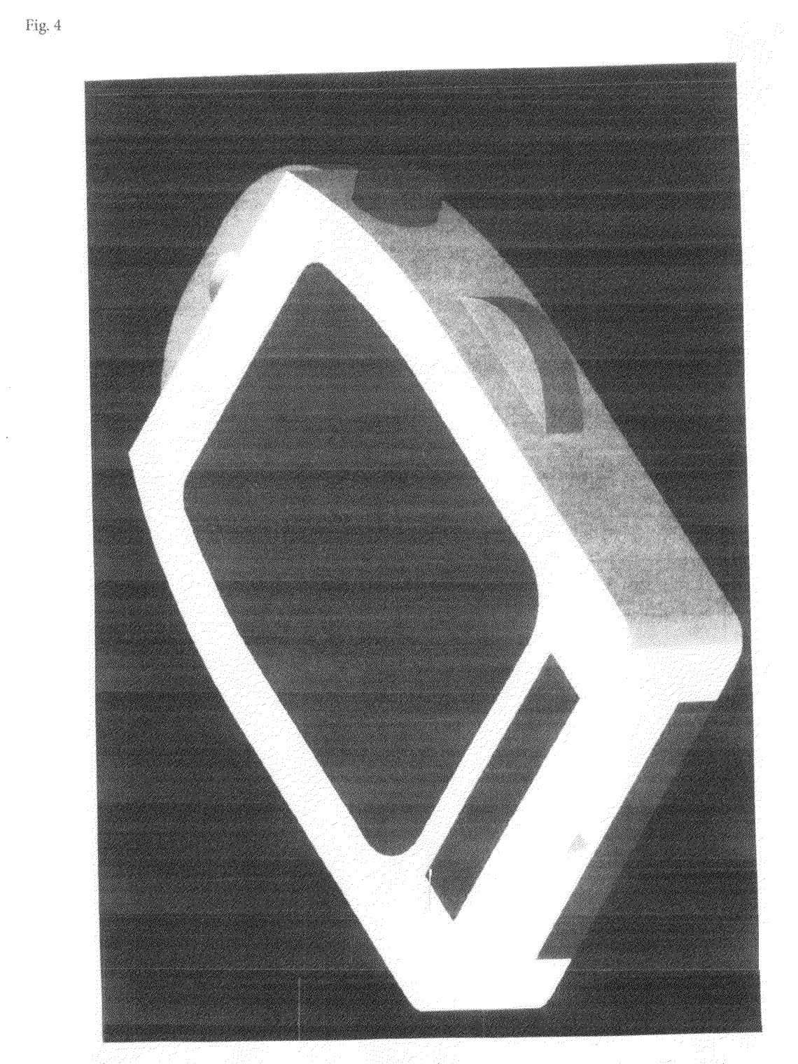

FIG. 5—A version of a potential screen shot of a quiescent device which when a button is pushed would show date, day and time as well as graphic image taken by VR when the individual i2C device is being set up.

FIG. 6—A version of a potential screen shot of an active device waiting for a successful fingerprint scan to enable toggling by the device licensee (toggler), by passing a finger over the slot or aperture on the lower surface of the device, see FIG. 1. In this depiction, when the fingerprint is successfully read, the smiley would change, for example, to a smile. The clock shows how much time is left to allow for a successful fingerprint i.d.

FIG. 7—A version of a potential screen shot of an active device at initiation after the toggler has been successfully identified, showing a depiction of the issue number and the options, which may be selected by using the thumbwheel. Conceptually, up to ten issues (toggles) may be sequenced and one of three to six options selected for each toggle. One can readily see how simple such a device can be to operate as contemplated.

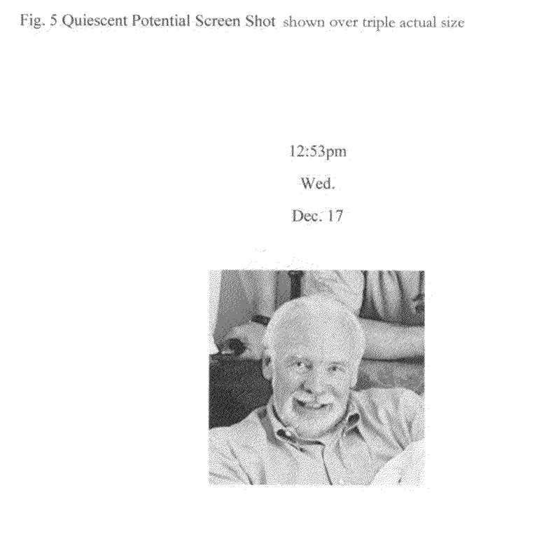

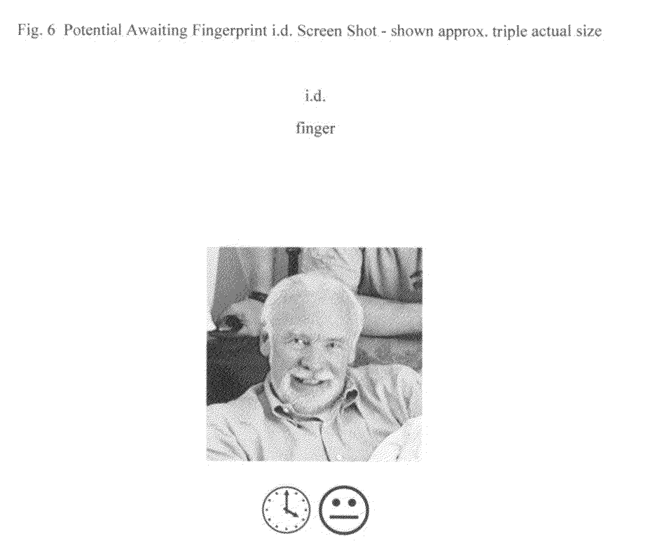

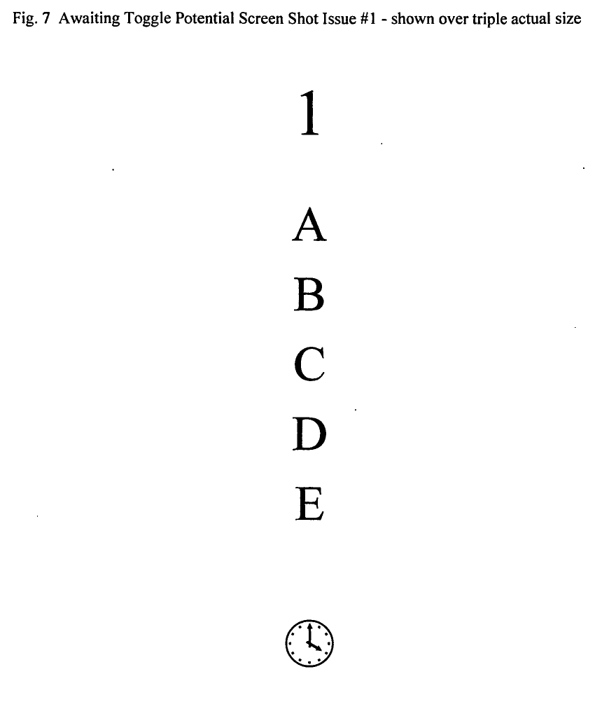

11.1.1. Internal parts of the i2C keychain device will be conventional miniaturized devices with the results encoded in a well-encrypted way; organization and placement of individual parts do not have critical bearing and therefore are not shown. Following is a word description of similar steps for this iteration to elaborate on those shown in the screen shots in FIG. 5, 6, 7.
11.1.2. Screen start at first button tap, FIG. 5: B/W photo of the licensee is embedded for view. Pushing the button starts the identification routine activating the logic and bringing up the internal thumb print i.d. capability and program. The toggler sweeps his fingers or thumb over an aperture until he is recognized with a match file program, which has been embedded in the device at issuance by VR. He or she receives a chirp and screen input that confirms the identification is accepted, or not. If not, there will probably be two more timed tries allowed before lockout. Multiple fingers may be scanned in case of injury to one. An option of a click of one button in a proper communication area would also connect to VR records and confirm that the licensee holder is vote eligible. In another version, there could also be supplemental pin key security recorded by sequencing clicks of the two buttons on the side of the device, or by using the thumbwheel to select numbers or letters on the screen.
11.2.1. Screen start and identification as in FIG. 6 as listed. Connecting with VR after the internal identification routine succeeds will authorize the person's eligibility to be a toggler on a given issue and will download the appropriate screens. If VR records are not accessible immediately, toggling may still occur but the result will not be uploaded and counted until after VR has positively, usually in an automated way, accepted the toggler as an authorized and registered voter.
11.2.2. In this depiction, after identification is complete, as in FIG. 7, the number 1 comes up on the screen denoting that a response is called for with the eligible answers simply symbolized by such as a) b) c) d) or e). The toggler will refer to the newspaper or internet listing to find the answer he wishes corresponding to a letter. He will scroll to the letter, depress and a chirp will let him know it has been recorded. There may also be a backlight button if the screen is too dim. Then he or she will click the lower button to move to the next toggle.
11.2.3. Same routine as this will be done through up to 9 or 10 toggles or as many lesser as the issue calls for. He can go back to the prior item by pressing a set button at any time or several times, and the number and answer will show. Pressing again and using the scroll wheel will allow him to change his response. Depressing a second button will advance to the next item. And so forth. When the list of toggles is concluded, the toggler signals completion by depressing a button for a longer period and hearing a different chirp. The screen will then sequence through the responses for verification of each selection.
11.2.4. Once that is accurate and complete, the toggler will hold the second button for an extended period to upload the result via an available communication medium. Success will be denoted by a third chirp tone. The clock face depicts how much time remains in the current toggling session.

### 12. CONCLUSIONS, RAMIFICATIONS AND SCOPE

12.1.1. Taken together, this system and mini i2C device represent a new approach to tap today's technology and human capability for improved citizenship input. The principles of its personal nature, keychain size, ability to use multiple levels of identification and response, ease of use, and security are directly related to the fundamental concept of providing one man:one vote (or toggle input), without bias or statistical error. These concepts are foremost factors inherent in any iteration of the system and device.
12.1.2. The whole process starts physically with the keychain i2C device, the heart of this application. The final shape ultimately may be an altered form factor, no matter, dependent on extended testing and parts availability. The end size will essentially be the smallest, most comfortable to hold, pocket and use, with screen surface area no more than two joined silver dollars that will technologically do the job. It will include three distinct areas, a fitment loop to fasten into a keychain, three actionable buttons and, depending on need found per testing, perhaps some type of cover.
12.1.3. Clear conclusions resulting from the population's use of the device and system are primarily meant for action and to blunt the current strong momentum of special interests, thereby helping to achieve better balance and more popular, transparent and reflective decisions by legislators.
12.1.4. The impact of i2C use also should have the effect that the citizen “buys into” his toggling, since he has been part of the process. Such “buy in” could, of course, include a need for personal cost or sacrifice. However, even if the citizen's toggle result is not in the majority, the idea of majority rule is well understood by nearly all, and the fact that his voice was heard should still help to support “buy in”.
12.1.4. While one embodiment of the device is necessarily conveyed in this application, it should be clear that a small touch screen application, for example, and possibly a unit with a cover, could also yield similar or better results, and that wireless printing and sound transposition of written words to assist the handicapped, are likely future derivations or embodiments.
12.1.5. If the program is a success in the US, a similar device and system may be licensed elsewhere on a basis yet to be determined. For the US, the patent owner will, without reservation, license use of the concepts set forth here to the US government, or a government agreed Not For Profit agency, for $1 a year.

1. A dedicated keychain sized device comprised of electronics, a screen and buttons that will, in conjunction with a related system, more rapidly, privately and securely accomplish toggling (personal thought input) as best allowed by current technology, by registered vote eligible citizens, to clearly convey such thoughts of up to the full voting population on specially set out topics, making information available in a clear manner to those in need of such feedback;
1-1. providing better, that is, simpler, faster, smaller, more broad, more personal, more precise, more in depth voter input on sequential topics in a more accurate, more secure and more reliable manner than any alternative device or system, taking all these factors together as having value in combination.
1-2. providing a substantial reduction in the potential for bias and statistical error prevalent today in most competitive methods of opinion gathering.
1-3. allowing toggling (input) on given local issues, a benefit that could be provided by the national government to local governments; that is, its use, as designed will inherently be scalable.
1-4. making it one of the few non class-based assets in the US, thereby universally tying together all citizens, rich and poor, by having them use exactly the same methods and device.
1-5. with a battery life more like a garage door opener or long life toll pay device than something as complicated as a computer or advanced cell phone that has to be recharged frequently, even daily.
1-6. opening a new channel for leadership support, which can be particularly useful where solutions are contentious, subject to lobbying, or major in scope, and such decisions are in need of timely, accurate, broad-based feedback.
1-7. having simple internal logic and memory, utilizing channels of public networks with carefully encrypted data being transmitted by verified users.
1-8. keeping encrypted responses in non-volatile memory until the next toggle session or until the outcome is irrefutable, should there be a need to do an audit.
1-9. embracing a version that could offer not just yea or nay input but provide degree of conviction as well.
1-10. providing that each device will be registered and licensed to, and will be for the use of, only that person and only once per issue, once it is placed in service.
1-11. providing that use will be feasible nearly wherever the licensee is physically located so long as there is a broad scale remote communication service nearby.
1-12. providing input can be tied back to precincts and individual voter records thereby encouraging fuller participation of all registered voters, so toggle results may also be separately summed by precinct but not be tied to the individual voter.
1-13. providing that statements and questions could be posed in a language other than English without changing notably the device itself or its operation.
1-14. having a design in such a way as to allow evolution in similar single purpose pocketable personal devices, as new features and technology permit.
1-15. providing for summed toggle results to be made known to media and publicly without charge, with inherent credibility, helping support majority rule.
1-16. increasing the percentage of eligible citizens who become registered voters and participate in a form of plebiscite that is at the heart of democracy.
1-17. having the potential to float an idea for which reaction may be uncertain to accurately gauge the breadth and depth of voter sentiment.
1-18. providing a positive check to limit toggler inputs to a single instance.

2. The device will also include both passive and active forms of identification, with a design and shape able to identify the bearer as a vote registered citizen of the US, with a small embedded photo further aiding immediate positive identification on demand, supplemented by an internally confirmed fingerprint scan.
